(19) United States
(12) Patent Application Publication
(10) Pub. No.: US 2001/0034656 A1
(43) Pub. Date: Oct. 25, 2001

(54) System and methods of online commerce for the efficient supply of parts or the like

(75) Inventors: Shawn D. Lucas, Heathrow, FL (US); Scott A. Anderson, Sanford, FL (US)

Correspondence Address: GREENBERG-TRAURIG, 1750 TYSONS BOULEVARD, 12TH FLOOR, MCLEAN, VA, 22102, US

(73) Assignee: parts.com, Sanford, FL (US)

(21) Appl. No.: 09/725,718

(22) Filed: Feb. 23, 2001

Related U.S. Application Data
(60) Provisional application No. 60/168,130, filed on Nov. 30, 1999.

(51) Int. Cl. G06F 17/60

(52) U.S. Cl. 705/26

(57) ABSTRACT

A business-to-business cost-effective part supply e-commerce solution for maximizing the efficiency of online commerce. A web-centric system and methods having a logistics and fulfillment model to offer users direct and collaborative purchasing having reduced processing costs. Parts and accessories are delivered to dealerships, garages, collision repair facilities and transportation fleets within hours or on an as-needed basis. Information is provided to dramatically reduce the time needed to make decisions and quickly adapt to market trends. Parts availability is instantly known and delivery time is made based upon the desires of the purchaser.

This application is related to and claims the benefit of provisional application No. 60/168,130 filed Nov. 30, 1999, the teachings of which are hereby incorporated herein in their entirety.

### BACKGROUND OF THE INVENTION

1. Field of the Invention

The present invention relates generally to the field of e-commerce and more particularly to the use of online commerce to optimize supply chain efficiency for delivering parts or the like to any location within hours.

2. Background of the Invention

Minute by minute everything in the physical world is wearing out. Day by day the cost of replacing these items is increasing. As a result billions of people around the world are making the decision to repair rather than replace. Some objects, such as computers, refrigerators, dishwashers and lawnmowers contain hundreds of parts; others like the automobiles contain thousands. The failure of a single component can render an object inoperative. The rebuilding process for these essential items hinges on the availability of and access to replacement parts.

What is needed is a fast efficient means for replacing defective parts so that items are returned to operation as quickly as possible. Heretofore inefficiencies within the parts distribution industry dictated an exceedingly time consuming parts search and retrieval process in spite of the fact that there are numerous suppliers and distributors spanning the country. In the automotive world the result is that vehicles often sit inoperable for days or even weeks awaiting necessary parts. This is unacceptable for today's consumer who lacks virtually any viable alternative for navigating the country's automobile dependent communities.

### SUMMARY OF THE INVENTION

The present invention offers an innovative business model and cost effective cutting edge e-commerce solutions to maximize the efficiencies of online commerce. The system and methods employ standardized means of communication for OEM part lines in a single marketplace, the use of applications service provider software for real time automated transaction, order placement, tracking, and inventory control in conjunction with an aggregation of information and content to improve the supply chain of parts.

To purchase auto parts, businesses log onto the innovative website and locate the desired part using an extensive catalog and/or parts illustrations. A simple click of a button adds the parts to a virtual shopping cart. Buyers may add and subtract parts from the shopping cart as they browse just as in a physical store. To execute an order, the buyer clicks on the “buy” button which then prompts them to supply shipping and delivery information through a secure socket layer e-mail or they may supply this by telephone. This information is stored on a secure server and need not be provided again by repeat buyers. The inventor automatically sends buyers an e-mail to confirm orders within minutes after the order is placed and then advises buyers when orders are shipped. Orders are accepted, validated, organized and placed by suppliers, wholesale distributors and parts dealers.

The most critical element in the business to business parts industry is the availability and time of delivery. A unique method utilizes an infrastructure of franchise dealers that stock and deliver parts. The most efficient location of the part within the nearest proximity to the order's place of origin is used to automate the ordering and fulfilling process.

### BRIEF DESCRIPTION OF THE DRAWINGS

FIG. 1 illustrates a screen print taken from the business to business web portal of the present invention;

FIG. 2 illustrates in schematic form the supplier network of the present invention;

FIG. 3 illustrates the supply chain relationships of the present invention;

FIG. 4 illustrates the relationship of the present invention to the original equipment manufacturers;

FIG. 5 illustrates the business to business relationships that could be conducted with the present invention;

FIG. 6 is an illustration in block diagram form of the supply chain model employed in the present invention;

FIG. 7 is a detailed illustration of the original equipment manufacturing order process according to the present invention;

FIG. 8 is a model in block diagram form of the aftermarket ordering process of the present invention; and

FIG. 9 illustrates the supplier processing transactions of the present invention.

### DETAILED DESCRIPTION OF THE PREFERRED EMBODIMENTS

The present invention offers an innovative business model and cost effective cutting edge e-commerce solution to maximize efficiencies of online commerce. Manufacturers who have been slow to embrace e-commerce are now flocking to join the internet boom. The e-commerce revolution is affecting virtually every market but will have a particularly large impact on the automotive industry because of its large presence in the economy. The present invention is an adaptable e-commerce solution that fits the needs of any company and offers unique advantages of multi-platform technology with total logistics of the parts supply chain.

The auto parts market is very large, comprising a large dollar value and many buyers and suppliers. The present chain includes wholesale distributors, jobbers and retailers in addition to the manufacturers. The supply chain often involves original equipment manufacturers (OEM), dealerships and installers of auto parts as well.

The present system and methods enable local and nationally recognized dealers, wholesalers, distributors and manufacturers to retain private label sites through an internet based application solution provider web portal. The present concept is shown by way of example as parts for automobiles can also include parts for a myriad of industries including aerospace, computers and peripherals, consumer electronics, light goods/appliances, household fixtures, garden/housewares, sporting goods, aviation, medical equipment, office equipment and manufacturing equipment.

Warehouse distributors, jobbers and retail stores must make significant investments in inventory, real estate and personnel for each location thus limiting the amount of inventory that can be economically stored in any location. Additionally warehouse distributors carry typically carry over 100 thousand unique part numbers and have inventories valued in the millions. The average dealership stocks less than 12,000 unique parts but has a parts inventory valued in the hundreds of thousand and allocates less than one percent (1%) of its inventory for discontinued parts. Therefore, consumer selection is limited due to the lack of physical inventory space and limited parts locating capabilities.

Additionally, auto dealers and other retailers cannot easily obtain necessary point of sale demographic and behavioral data on buyers. This inefficient flow of information limits the ability to act on real time information and limits the effectiveness of direct marketing campaigns and personalized services. Trends regarding the needed parts will not be recognized.

The present invention restructures the supply chain in which suppliers typically sell auto parts to manufacturers who in turn sell directly to their franchisees, retailers or a network of distributors.

There are multiple market segments in the automobile part industries, each providing a variety of opportunities for the use of online commerce. The two general areas are referred to as the OEM market and the replacement or aftermarket sales.

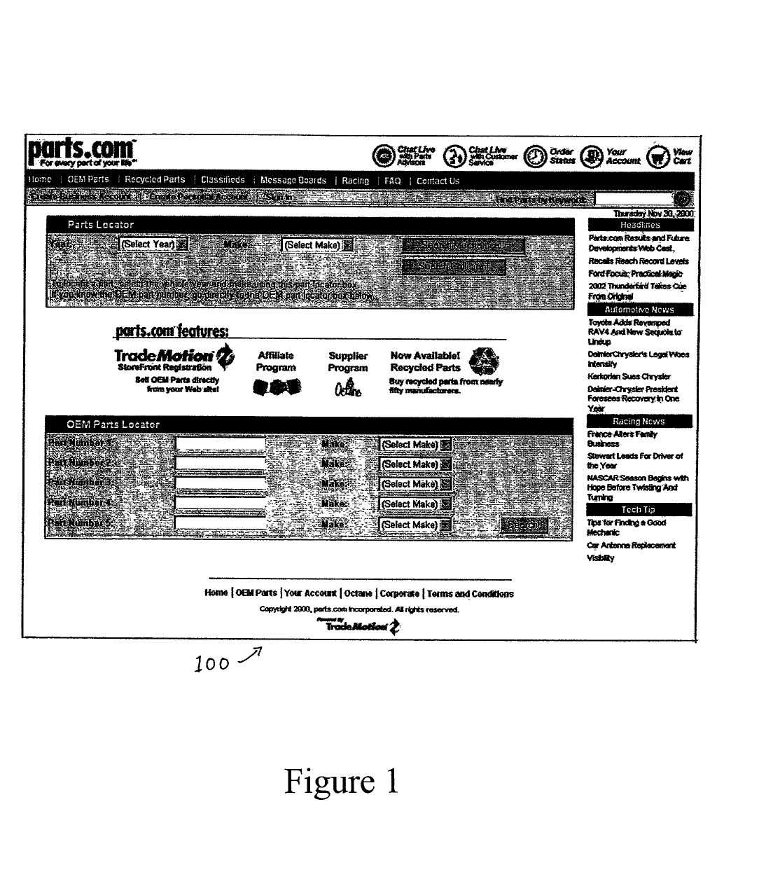

As shown in FIG. 1 the present invention is a business to business marketplace which provides a web-based fully integrated auto supply chain, web processing in real time transactions, order placements, tracking, inventory control and the aggregation of information content for improved market penetration. To purchase auto parts the businesses log onto the internet website portal 100 and locate their desired part using extensive catalog and/or parts illustrations. Then they may simply click a button to add the part to the virtual shopping cart. Buyers may add/subtract parts with the shopping cart as they browse just as in a physical store. To execute orders buyers click on the “buy” button which then prompts them to supply shipping and credit card information through secured socket layers or via telephone. This information is stored and may not be provided again by repeat buyers. Most of the parts are available for immediate shipment but others are available for shipping within 48-72 hours. Out of print parts are generally available within 4-6 weeks although not all auto print parts may be available. Buyers may select a variety of delivery options including immediate or night and other shipping options including international. Notice of the order is sent via e-mail to the buyer.

The most critical elements in the business to business parts industry are the availability of parts and time to delivery. Traditional auto parts distributions systems are plagued by the lack of one centralized parts location and use multiple proprietary inventory systems which can not interface to each other. An exorbitant amount of time and money is wasted in the effort to locate necessary parts, transport the parts from distant locations, manually process orders and transfer funds either by telephone or facsimile. By using the present invention, automobile dealerships, service centers and garages can save money by eliminating wholesale distributors, jobbers and retailers. Additionally a tremendous of time is saved by instantly locating the availability of parts.

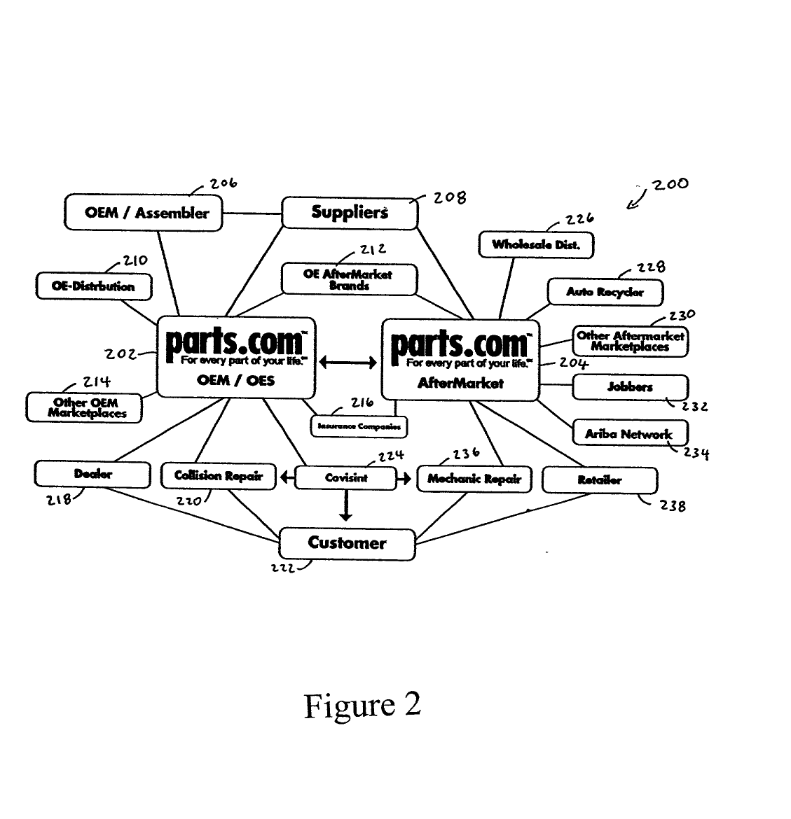

Shown in FIG. 2 is the OEM supplier network level 200. The invention comprises an OEM side 202 and aftermarket side 204. Manufacturers 206 and suppliers 208 interface with each other as well as with the web portal 100. Additionally, original equipment distribution may be made as in block 210 and the original equipment aftermarket brands can be sold block 212. Other OEM marketplaces 214 and insurance companies 216 can interface to the website 202. Also interfacing with the OEM website 202 are dealers 218, collision repair shops 220 and customer 222. The customer may be a major automobile manufacturer and have its own electronic marketplace such as block 224.

On the aftermarket side of the present invention 204 there is connected suppliers 208 OE aftermarket brands 212 as well as wholesale distributors 226, auto recyclers 228, other aftermarket marketplaces 230, and jobbers 232. Other proprietary networks 234 may interface with the aftermarket web portal 204 to provide smooth interface to others supply channels. Mechanic repair 236 and retailer 238 also interface with the aftermarket web portal 204. Web portals 202 and 204 are all part of the inventive system and methods and operate seamlessly as shown by arrow 240.

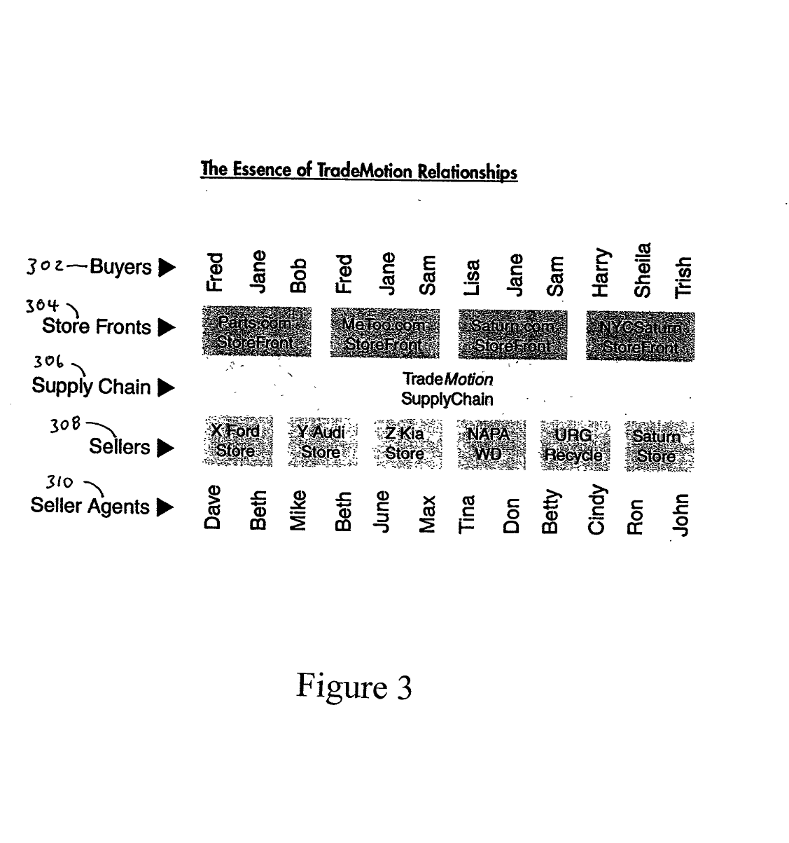

The essence of the relationships of the present invention are shown in FIG. 3. Buyers 302, and storefronts 304, are connected through the present supply chain model 306 with sellers 308, and selling agents 310. Buyers maybe consumers or businesses depending on storefront rules. Buyers may invite or register directly depending upon the storefront rules. Consumers may shop before registering whereas businesses must pre-register. Buyers may register for several storefronts independently but they see no relationship between the storefronts. If a buyer registers with storefront X he will need to register separately for storefront Y even if using the same logon name and e-mail address. No two storefronts may share a single venue like a website otherwise login names could be ambiguous. However a single storefront may exist at several venues like multiple websites or web-enabled cell phones. Pricing is determined based on buying agreements with the individual storefront.

Sellers may be dealerships, distributors, suppliers, manufacturers, recyclers, etc. Sellers access storefronts for a fee based on the selling agreements. Sellers get their requests for “orders” and returns from any storefront with a relevant selling agreement in place. The processing is conducted across the supply chain using various computer languages such as XML, HTML, or direct to DMS.

All functionality of the inventive website is available to the storefronts. Support is made for one or more catalogs. Seller agents can assist in determining what is available and assist buyers in interfacing the supply chain.

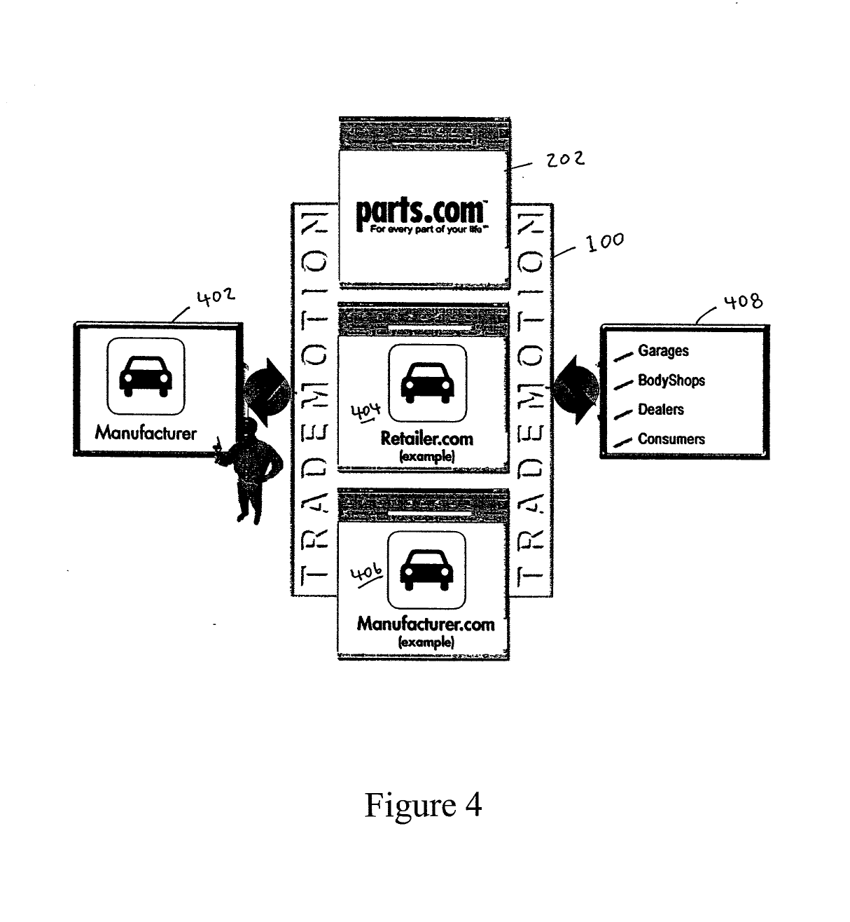

Shown in FIG. 4 is a relationship between the inventive system and methods and the OEM dealerships. The manufacturer 402, interfaces through the web portal 100 to access the business to business marketplace 202. A retailer website 404 and a manufacturer website 406 are connected to the parts portal 202. Also connect to the parts portal are customers shown in box 408 such as garages, body shops, dealers or consumers.

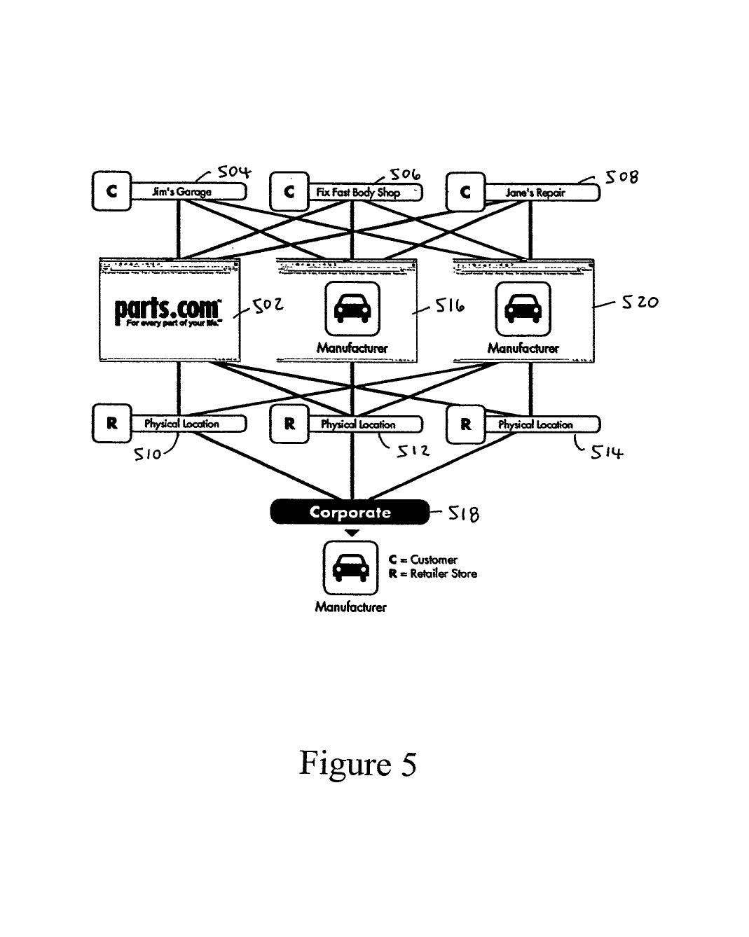

The present invention provides a rich set of e-commerce features that allow buyers to transact business either at a seller's site or through the parts.com portal. Illustrated in FIG. 5 is the present parts.com portal 502 which can interface to any of the customers 504, 506 or 508 as well as retailers 510, 512 and 514. Separately various sellers sites such as 516 can interface to the customers 504, 506, and 508 as well as to a corporate site 518 which represents a manufacturer. Likewise, manufacturer 520 can have a website which interfaces to all of the customers and all of the retail locations depending upon the agreements that they have put into place.

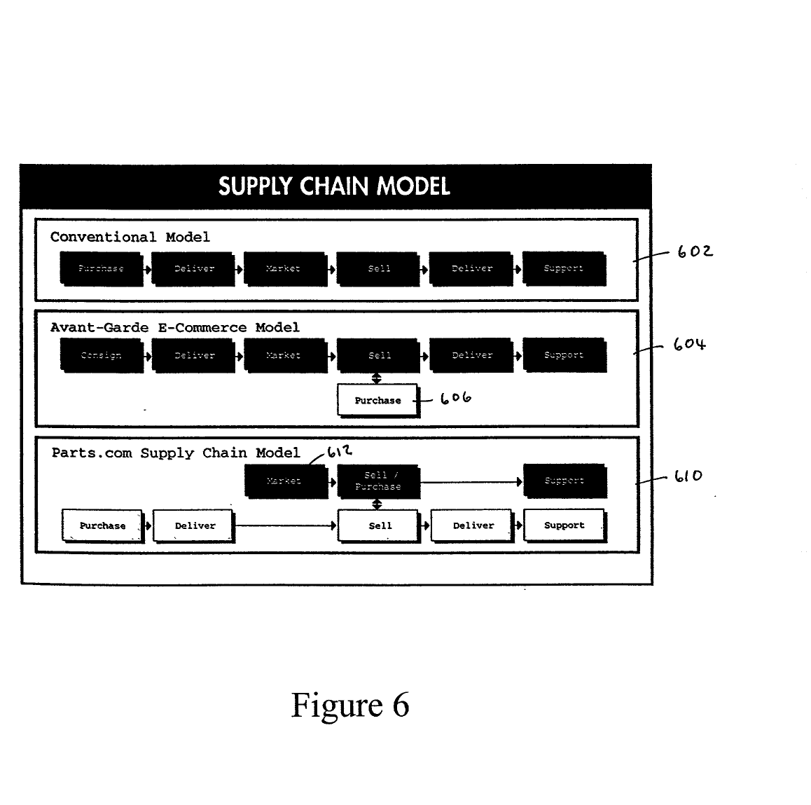

In the present invention the business model does not anticipate warehousing or stocking of parts inventory but rather relies upon rapid fulfillment by major suppliers, distributors and wholesalers in the buyers local area having a broad selection of parts. The present invention focuses on redefining the supply chain model. Illustrated in FIG. 6 is a conventional supply chain model is shown as 602 wherein a purchase is made followed by delivery of that purchase. That purchase is then put on the market, subsequently sold, and delivered to the ultimate customer followed by customer support. A revised supply chain model is shown as 604 wherein a product is consigned, then delivered to be marketed, sold to a purchaser, delivered to the buyer and supported. Purchase 606 is finally made after the marketing is done. The one making the product available is not the owner of the part. In the present inventive business model, the supply chain 610, employed is such that the market 612 offers for sale a product, the purchase and delivery is made upon the sale. The purchased part is then delivered to the ultimate customer and supported.

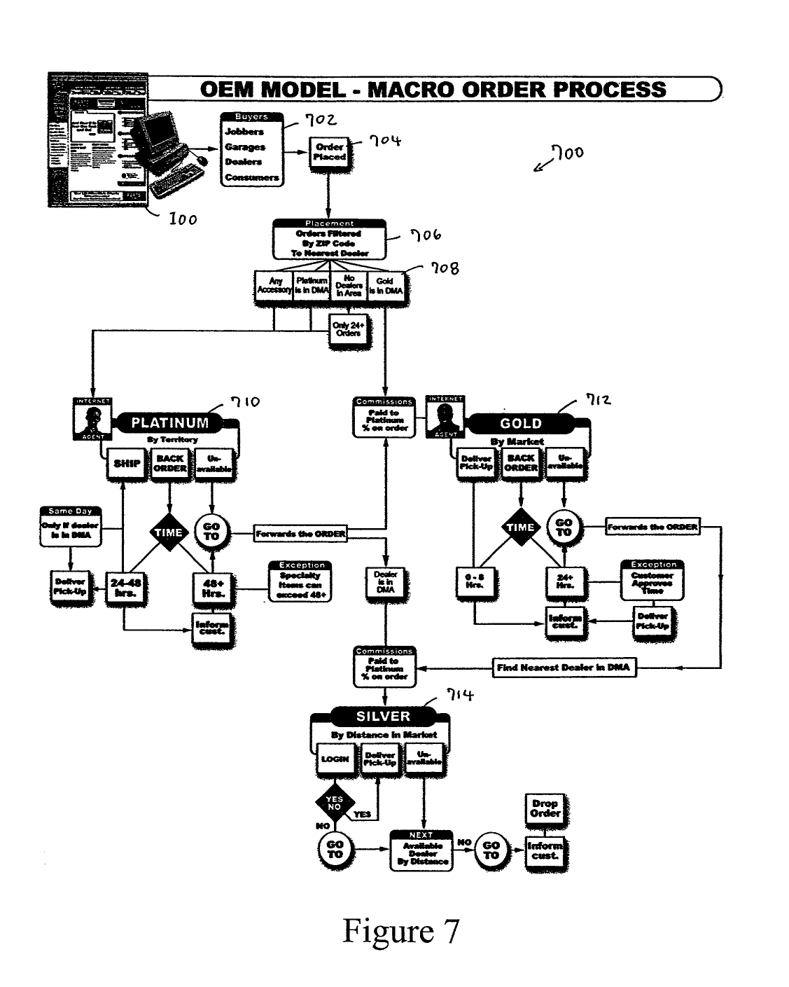

Illustrated in FIG. 7 in more detail is the macro order process 700, for the original equipment manufacturer supply chain model. The present invention envisions a business model and process that utilizes an intricate network that is based on a regional structure within a country such as five regions within the United States. The five regions are broken down into three tiers, which could for example represent the 34 dominant vehicle lines. The parts.com network suppliers are selected from an elite group of nationwide dealers that excel in both parts, sales and distribution. The tiers in the example are called platinum, gold and silver. Shown in FIG. 7 is the web portal 100 interfacing with buyers 702 who place orders 704. Once placed the orders are filtered in step 706 using various business rules step 708. The order is routed first if possible with the platinum supplier 710. The platinum suppliers hold the first tier primary fulfillment opportunity to deliver OEM parts in their respective market areas. Platinum suppliers pack and ship parts for their vehicle line responsibility through a courier such as Federal Express or UPS. It is expected only small numbered on the order of 100-200 suppliers will make up the entire platinum tier to serving the world's automotive parts and accessory needs.

The next tier is the gold suppliers 712. If for any reason a platinum supplier cannot fulfill an order within a given time frame the order is then referred to a gold supplier network entity which may comprise approximately 6,000-10,000 suppliers throughout the country. In every case, however, platinum suppliers enjoy profit participation from sales referred to the gold supplier 712. The gold supplier operates within the same regional territories as the platinum supplier. Gold suppliers earn on the profit from their sales.

The third tier is the silver tier 714. The third integral tier is the silver supplier network which provides the foundation for the largest online parts locator network. Silver network associates consist of traditional dealers or any agency that supplies and inventories automotive parts and accessories. The silver level is the final one in which a parts request defaults when both the platinum and gold suppliers cannot deliver on a product request. Silver associates are eligible to place parts and accessories online for sale and trading.

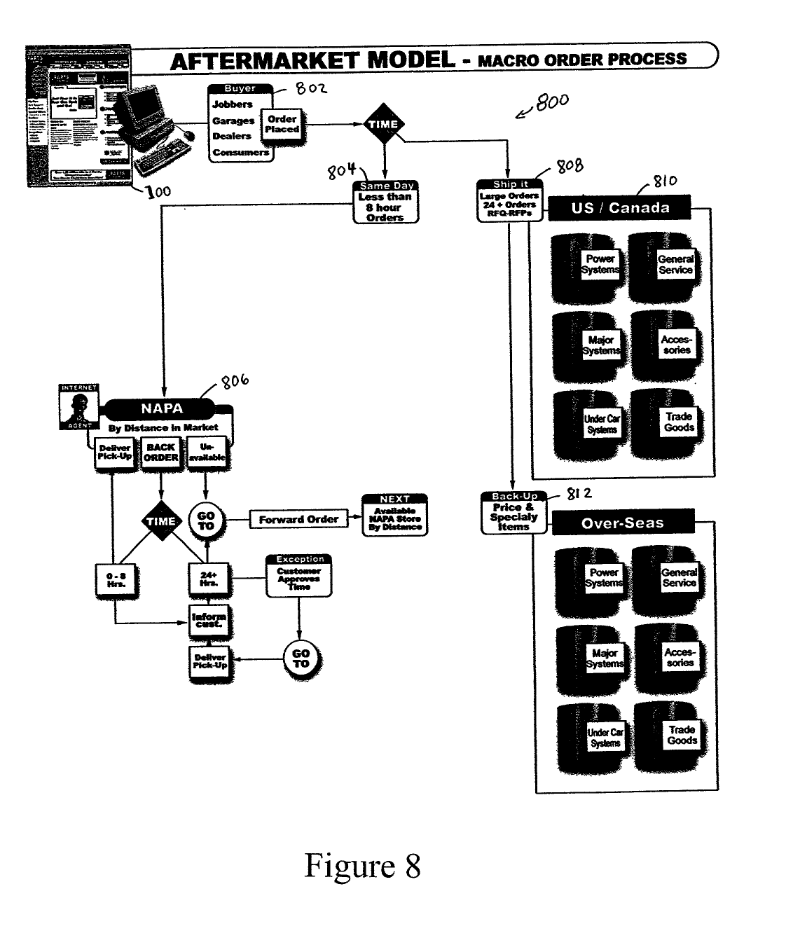

An aftermarket business model order process 800, is shown in FIG. 8. Business to business portal 100 can be accessed by buyers 802 for the placement of orders. If orders are able to ship in less than 8 hours, step 804, a local parts supplier as a member of the inventive network 806 may ship the parts. If the parts are not able to be delivered within 8 hours as shown in step 808 the order is routed to the U.S. and Canadian market 810 for shipment within 24 hours. If the order can not be full filled with 24 hours, the request is sent for backup fulfillment, step 812.

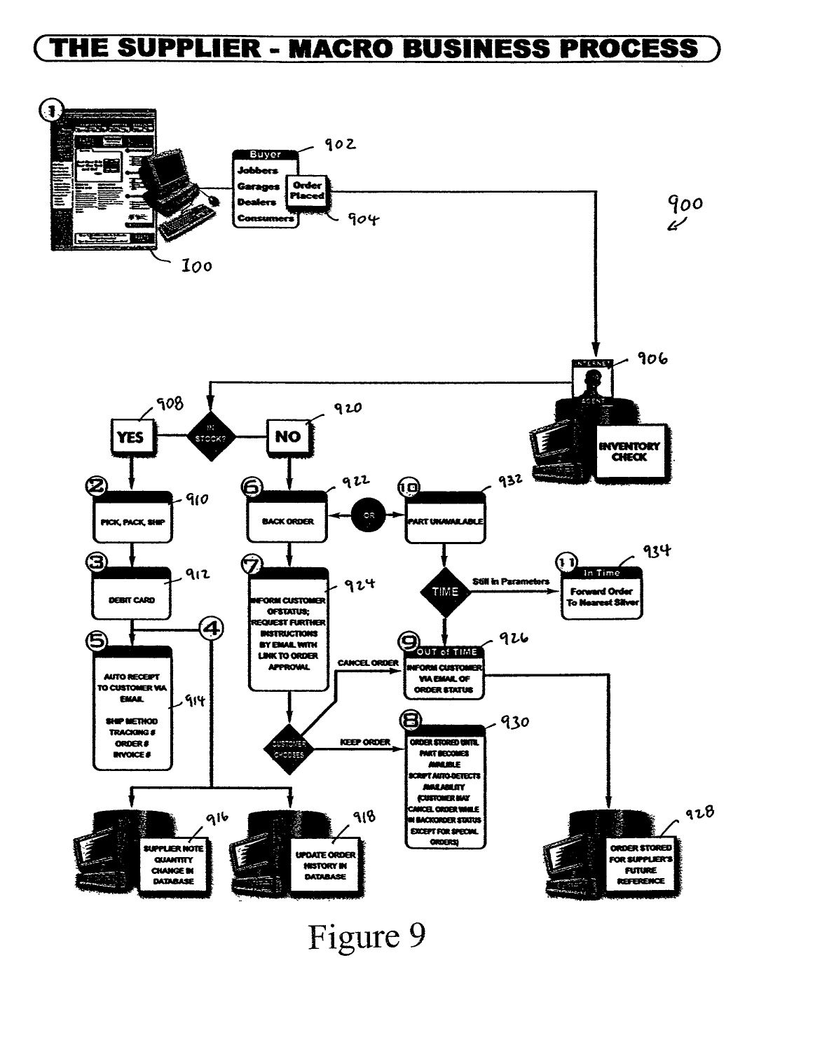

An example of the supplier business transaction model 900, is shown in FIG. 9. Again the present supply portal 100 is accessed by buyers 902 for placement of orders step 904. An Internet agent, shown here as a human operator 906, who can monitor the order process and assist in placement of the order and check the inventory or route the order to provide the human touch and level of intelligence that the automated system may not have. If the part requested is in stock step 908, it is picked and packed in step 910, payment is made in step 912, and the part sent to the customer in step 914. Acknowledgment to the customer that it is being sent. Any changes in the order can be noted in step 916. An updated history is kept on file in step 918. If the part is not in stock, step 920, it may be back ordered in step 922. The customer is informed in step 924 and the customer can choose to cancel the order in step 926, with a record retained as in step 928. The customer may choose to keep the order until the part becomes available as in step 930. Alternatively, if the part is unavailable as in step 932, the customer is notified and if still within the time parameters given by the customer, the part order can be routed to the nearest silver supplier 934.

What has been shown is a unique business model, marketplace and e-commerce solution to the supplying of parts worldwide. It should be understood that while the present system and methods has been shown relative to the automotive parts marketplace, the inventive concepts and techniques may be applied across a myriad of part types and industries. Variations may be made to the invention without departing from the spirit and scope of the appended claims.

What is claimed is:

1. A method of enabling electronic commerce over a network to provide a single source of parts, the method comprising the steps of:
using a first processing system to maintain an order processing unit corresponding to a parts supply source and authorized users for a business of providing parts, the order processing unit for receiving and processing orders for said business; and
receiving a signal for invoking the order processing unit from a remote processing system via a network, the signal having been transmitted from the remote processing system in response to a selection of a hypermedia link; and
using the first processing system to operate the order processing unit in response to the signal.

2. The method according to claim 1, wherein the remote processing system provides a network site of a supplier of parts, and wherein the network site provides the hypermedia link to the order processing unit.

3. The method according to claim 2, wherein the network site is a World Wide Web site of a supplier of parts.

4. The method according to claim 1, wherein the hypermedia link comprises information specifying parts availability.

5. The method according to claim 4, wherein the hypermedia link further comprises information specifying possible delivery time of parts.

6. The method according to claim 5, wherein the hypermedia link further comprises tiers of potential suppliers of parts according to availability and delivery time.

7. A processing system for providing a single source for the supply of parts comprising:
means for maintaining an order processing unit corresponding to a single source supplier of parts, the order processing unit for receiving and processing orders for said single source supplier of parts; and
means for receiving a signal for invoking the order processing unit from a remote processing system via a network, the signal having been transmitted from the remote processing system in response to a selection of a hypermedia link; and
means for invoking the order processing unit in response to the signal.

8. The processing system according to claim 7, wherein the remote processing system provides a network site of a single source supplier of parts, and wherein the network site provides the hypermedia link to the order processing unit.

9. The processing system according to claim 8, wherein the network site is a World Wide Web site of a single source supplier of parts.

10. The processing system according to claim 7, wherein the hypermedia link comprises information specifying availability of ordered parts.

11. The processing system according to claim 10, wherein the hypermedia link further comprises information specifying delivery time of parts.

12. The processing system according to claim 11, wherein the hypermedia link further comprises tiers of potential suppliers of parts according parts availability and delivery time.
